(19) United States
(12) Patent Application Publication
(10) Pub. No.: US 2023/0173455 A1
(43) Pub. Date: Jun. 8, 2023

(54) HYDROCARBON ADSORBENT

(71) Applicant: Korea University Research and Business Foundation, Seoul (KR)

(72) Inventors: Chun Yong KANG, Yongin-si (KR); Chang Hwan KIM, Seongnam-si (KR); Jungkyu CHOI, Seoul (KR); Eunhee JANG, Seoul (KR); Jin Seong KIM, Seoul (KR); La Young CHOI, Seoul (KR)

(73) Assignee: Korea University Research and Business Foundation, Seoul (KR)

(21) Appl. No.: 18/102,238

(22) Filed: Jan. 27, 2023

Related U.S. Application Data
(63) Continuation-in-part of application No. 16/913,466, filed on Jun. 26, 2020.
Application No. 16/913,466 is a continuation of application No. PCT/KR2018/016905, filed on Dec. 28, 2018.

(30) Foreign Application Priority Data
Dec. 29, 2017 (KR) 10-2017-0183959

(51) Int. Cl. B01J 20/18; B01J 20/02; B01J 20/28; B01D 53/94; B01D 53/02

(52) U.S. Cl. CPC B01J 20/183; B01J 20/0237; B01J 20/28007; B01D 53/9445; B01D 53/02; B01D 2255/912; B01D 2253/1085; B01D 2257/702; B01D 2259/4566

(57) ABSTRACT

A hydrocarbon adsorbent according to one exemplary embodiment of the present invention includes a beta zeolite containing copper, in which a Si/Al molar ratio of the beta zeolite is 12.5 to 150, and the amount of the copper contained is 1 wt % to 10 wt %.

### CROSS-REFERENCE TO RELATED APPLICATION(S)

This application is a continuation in part of U.S. patent application Ser. No. 16/913,466 filed on Jun. 26, 2020, the entire disclosure of which is incorporated herein by reference for all purposes.

### TECHNICAL FIELD

The present invention relates to a hydrocarbon adsorbent with improved hydrocarbon adsorption capacity.

### BACKGROUND

As interest in air pollution increases, regulations for vehicle exhaust gasses such as CO, NOₓ, HC (hydrocarbons), and PM (particulate matter) in places such as the United States and Europe are being strengthened. Among them, the HC is mostly oxidized by three-way catalysts (TWCs), and the three-way catalysts are activated at a temperature of about 200 to 300° C. or higher, and thus, in a cold-start section in which the three-way catalysts are not activated, HC corresponding to 50 to 80% of a total HC emission is emitted. In order to reduce the HC emission, studies on a hydrocarbon adsorbent (HC trap) have been conducted. The hydrocarbon adsorbent is a device that adsorbs HC emitted in the cold-start section and desorbs the HC when the three-way catalyst becomes activated at a temperature of 200 to 300° C.

As a hydrocarbon adsorbent, zeolite having high physical and chemical stability has been extensively studied. Performance of the hydrocarbon adsorbent is tested by measuring adsorption/desorption of propene and toluene, which are typical HC emission materials. Studies on the performance of the hydrocarbon adsorbent according to a zeolite structure, a Si/Al ratio, and whether or not metal impregnation is performed, have been conducted.

### SUMMARY OF THE INVENTION

### Technical Problem

The present invention has been made in an effort to provide a hydrocarbon adsorbent with improved hydrocarbon adsorption capacity.

### Technical Solution

In order to solve the problem, a hydrocarbon adsorbent according to an exemplary embodiment of the present includes a ZSM-5 zeolite containing copper, and an Si/Al molar ratio of the ZSM-5 zeolite may be 11.5 to 40, and a content of the copper may be 1 wt % to 10 wt % based on the total weight of the ZSM-5 zeolite.

All the wt % of the content of the copper herein are based on the total weight of the ZSM-5 zeolite.

A content of the copper may be 3 wt % to 7 wt % based on the total weight of the ZSM-5 zeolite.

When the Si/Al molar ratio is 11.5 to 40 and the content of the copper is 3 wt % to 10 wt %, efficiency of the hydrocarbon adsorbent may be 55% or greater.

When the Si/Al molar ratio is 25 to 40 and the content of the copper is 5 wt % to 10 wt % based on the total weight of the ZSM-5 zeolite, efficiency of the hydrocarbon adsorbent may be 60% or greater.

When the Si/Al molar ratio is 15 to 25 and the content of the copper is 3 wt % to 5 wt % based on the total weight of the ZSM-5 zeolite, efficiency of the hydrocarbon adsorbent may be 70% or greater.

The hydrocarbon may include a hydrocarbon having 5 or more carbon atoms.

A hydrocarbon adsorbent according another exemplary embodiment includes a beta (BEA) zeolite containing copper, a Si/Al molar ratio of the beta zeolite may be 12.5 to 19, and a content of the copper may be 1 wt % to 10 wt % based on the total weight of the beta zeolite.

A content of the copper may be 3 wt % to 10 wt % based on the total weight of the beta zeolite.

A hydrocarbon eliminating system according to another exemplary embodiment of the present invention includes: trapping hydrocarbon by using ZSM-5 zeolite or beta zeolite containing copper at a temperature of 150° C. or less; desorbing the trapped hydrocarbon at a temperature of 150° C. or higher; and oxidizing the desorbed hydrocarbon. A Si/Al molar ratio of the ZSM-5 zeolite may be 11.5 to 40 and a content of the copper may be 1 wt % to 10 wt % based on the total weight of the ZSM-5 zeolite or the beta zeolite, and a Si/Al molar ratio of the beta zeolite may be 12.5 to 19 and a content of the copper may be 1 wt % to 10 wt % based on the total weight of the ZSM-5 zeolite or the beta zeolite.

A hydrocarbon adsorbent according to another exemplary embodiment of the present includes: a beta zeolite containing copper, in which a Si/Al molar ratio of the beta zeolite is 12.5 to 150, a content of the copper is 1 wt % to 10 wt % based on the total weight of the beta zeolite, and efficiency of the hydrocarbon adsorbent is 50% or greater.

The Si/Al molar ratio of the beta zeolite may be 19 to 65, the content of the copper may be 3 wt % to 10 wt % based on the total weight of the beta zeolite, and efficiency of the hydrocarbon adsorbent may be 70% or greater.

The hydrocarbon may include a hydrocarbon having 3 to 15 carbon atoms.

The beta zeolite containing copper may have a peak in the range of 20 value of 5° to 10° in an X-ray diffraction (XRD) pattern, and a Full Width at Half Maximum (FWHM) existing in the range of the 20 value of 5° to 10° may be 1.2 to 1.5.

Each of the beta zeolite containing copper and the beta zeolite containing no copper may have a peak in the range of 20 value of 5° to 10° in the XRD pattern, and in the FWHM existing in the range of the 20 value of 5° to 10°, a ratio of an FWHM (FWHM_bare) of the beta zeolite containing no copper to an FWHM (FWHM_Cu) of the beta zeolite containing copper may be less than 1.

The amount of adsorbed propene of the hydrocarbon adsorbent may be 0.03 mmol/g or greater.

A hydrocarbon eliminating method according to another exemplary embodiment of the present includes: trapping hydrocarbons by using beta zeolite containing copper at a temperature lower than 150° C.; desorbing the trapped hydrocarbon at a temperature of 150° C. or greater; and oxidizing the desorbed hydrocarbon, in which a Si/Al molar ratio of the beta zeolite is 12.5-150 and a content of the copper is 1 wt % to 10 wt % based on the total weight of the beta zeolite.

The copper may include copper ions or copper oxide, the copper oxide may be provided in the form of particles of 10 nm or less on a surface of the beta zeolite, the copper ion may trap a hydrocarbon at temperatures of 150° C. or lower, in the oxidizing operation, the hydrocarbon may be oxidized, and the oxidizing operation may be performed at 150° C. or higher.

### Advantageous Effects

As described above, the present invention provides a hydrocarbon adsorbent with improved hydrocarbon adsorption capacity.

### BRIEF DESCRIPTION OF THE DRAWINGS

FIG. 1 illustrates a configuration of purifying exhaust gas of a gasoline vehicle with a three-way catalyst.

FIG. 2 illustrates a configuration in which a hydrocarbon adsorbent adsorbs and desorbs hydrocarbon.

FIG. 3 illustrates a hydrocarbon eliminating system according to an exemplary embodiment of the present invention.

FIG. 4 illustrates a manufacturing process according to Example 1.

FIG. 5 illustrates an image of a sample manufactured in Example 1.

FIG. 6 illustrates a process condition of pre-treatment, adsorption, and desorption in Evaluation Example 1.

FIG. 7 illustrates a process condition and a reaction flowchart of an adsorption/desorption evaluation test in Evaluation Example 1.

FIG. 8 illustrates a result of measuring adsorption performance of C₃H₆ in Evaluation Example 2.

FIG. 9 illustrates a result of measuring adsorption performance of C₇H₈ in Evaluation Example 2.

FIG. 10 illustrates a result of measuring adsorption performance of C₃H₆ in Evaluation Example 3.

FIG. 11 illustrates a result of measuring adsorption performance of C₇H₈ in Evaluation Example 4.

FIG. 12 and FIG. 13 illustrate a result of measuring adsorption and purification performance of a sample manufactured in Example 1.

FIG. 14 illustrates a result of measuring adsorption performance in Evaluation Example 5.

FIG. 15 is a TEM image of BEA Si/Al 12.5 to which 5% of Cu is added.

FIG. 16 is an XRD result of a hydrocarbon adsorbent according to an exemplary embodiment of the present invention.

FIG. 17 is a CST graph for the hydrocarbon adsorbent according to the exemplary embodiment of the present invention.

FIG. 18 is a result of evaluating the performance of the hydrocarbon adsorbent according to the exemplary embodiment of the present invention.

FIG. 19 is a result of confirming the propene adsorption performance of the hydrocarbon adsorbent of the present invention.

### DETAILED DESCRIPTION

The present invention will be described more fully hereinafter with reference to the accompanying drawings, in which an exemplary embodiment of the invention is shown. As those skilled in the art would realize, the described exemplary embodiment may be modified in various different ways, all without departing from the spirit or scope of the present invention.

A hydrocarbon adsorbent according to an exemplary embodiment of the present invention will now be described in detail with reference to the drawings.

A hydrocarbon adsorbent according to an exemplary embodiment of the present invention includes a ZSM-5 zeolite containing copper, a Si/Al molar ratio of the ZSM-5 zeolite is 11.5 to 40, and a content of the copper is 1 wt % to 10 wt % based on the total weight of the ZSM-5 zeolite. All the wt % of the content of the copper herein are based on the total weight of the ZSM-5 zeolite.

Depending on the molar ratio and the content of the supported copper, it is possible to provide a hydrocarbon adsorbent with significantly improved hydrocarbon adsorption capacity.

That is, according to the present invention, adsorption performance, especially adsorption performance at a high temperature, may be improved by controlling the Si/Al ratio and the content of the supported Cu of the zeolite, and it is possible to rapidly deoxidize and simultaneously desorb hydrocarbon through a combination of a transition metal oxide and a hydrocarbon trap.

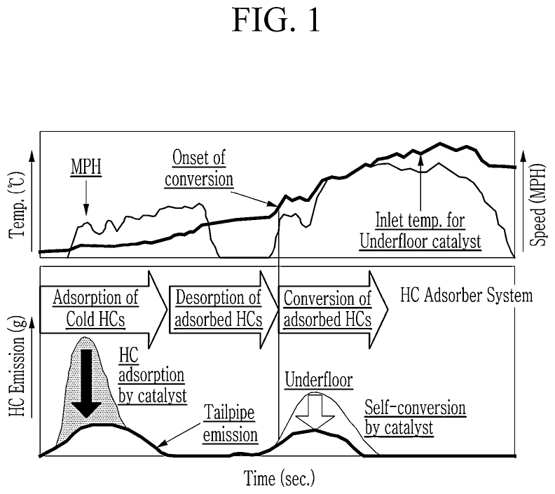

FIG. 1 illustrates a configuration of purifying exhaust gas of a gasoline vehicle with a three-way catalyst. Referring to FIG. 1, exhaust gas of a gasoline vehicle is purified by a three-way catalyst, and when a temperature of the catalyst is 400° C. or higher, the catalyst has purification performance of about 100%. However, in a cold-start section immediately after an engine starts, the three-way catalyst may not be normally operated, thus the exhaust gas is not purified and is discharged into the atmosphere. Particularly, it is known that about 70% of the hydrocarbons are discharged in the cold-start section.

However, in this exemplary embodiment, since the zeolite-based hydrocarbon adsorbent is introduced into the exhaust gas system, until a warm-up operation of the three-way catalyst is completed, the hydrocarbons discharged in the cold-start section are adsorbed by the hydrocarbon adsorbent, and then, when the hydrocarbon is desorbed from the hydrocarbon adsorbent at the end of the warm-up of the three-way catalyst, it may be purified through the three-way catalyst.

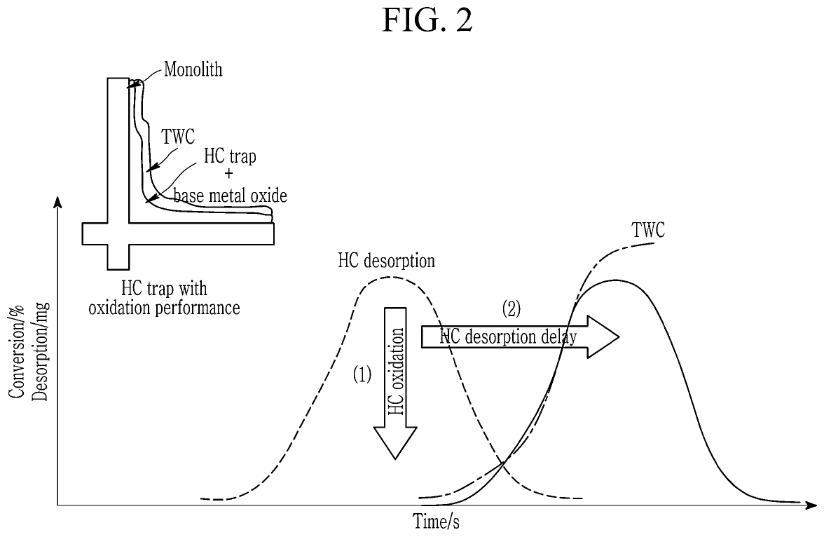

FIG. 2 illustrates a configuration in which a hydrocarbon adsorbent adsorbs and desorbs hydrocarbon. Referring to FIG. 2, since a desorption time of hydrocarbon is delayed in an adsorbent supporting copper, compared to an adsorbent not supporting copper, the hydrocarbon may be oxidized and purified simultaneously with desorption.

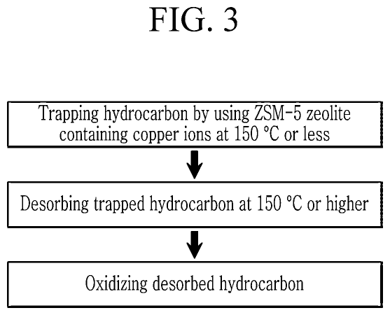

FIG. 3 illustrates a hydrocarbon eliminating system according to an exemplary embodiment of the present invention. Referring to FIG. 3, an exemplary embodiment of the present invention includes trapping hydrocarbon by using ZSM-5 zeolite containing copper ions and copper oxide at a temperature of 150° C. or less, desorbing the trapped hydrocarbon at a temperature of 150° C. or higher, and oxidizing the desorbed hydrocarbon.

In this case, a Si/Al molar ratio of the ZSM-5 zeolite may be 11.5 to 40, and a content of copper may be 1 wt % to 10 wt % based on the total weight of the ZSM-5 zeolite. Remarkable hydrocarbon trapping properties are obtained in the above range.

A carbon absorbent according to an exemplary embodiment of the present invention includes a beta (BEA) zeolite containing copper, and a Si/Al molar ratio of the beta zeolite is 12.5 to 150, a content of the copper is 1 wt % to 10 wt % based on the total weight of the beta zeolite, and efficiency of the hydrocarbon adsorbent is 50% or greater.

In particular, in the beta zeolite containing copper, a Si/Al molar ratio is 19 to 65, the content of the copper is 3 wt % to 10 wt % based on the total weight of the beta zeolite, and efficiency of the hydrocarbon adsorbent is 70% or greater.

The exemplary embodiment of the present invention relates to the beta zeolite containing copper, and the beta zeolite acts as an adsorbent for hydrocarbon. The hydrocarbon adsorbent is capable of adsorbing and/or eliminating hydrocarbon in a low temperature starting section at which the Three-Way Catalysts (TWCs) do not exhibit activity, so that when the hydrocarbon adsorbent is used for automobiles, the hydrocarbon adsorbent is used together with the three-way catalyst to assist the three-way catalyst.

The hydrocarbon adsorbent of the present invention may adsorb hydrocarbon, and in this case, the hydrocarbons may have 3 to 15 carbon atoms. The hydrocarbon adsorbent may easily adsorb hydrocarbon composed of small molecules, such as propene (C₃H₆), having three carbons atoms.

In general, the hydrocarbon adsorbent used at low temperatures are difficult to oxidize the hydrocarbons, so that the hydrocarbon adsorbent adsorbs hydrocarbon by a method of physically adsorbing hydrocarbon through pores.

On the other hand, in the hydrocarbon adsorbent according to the present exemplary embodiment, the beta zeolite further includes copper, so that the hydrocarbon adsorbent may adsorb even hydrocarbon that is difficult to be adsorbed through pores because the molecular size is too small. Specifically, the crystal structure of the beta zeolite is determined by the ratio of Si/Al, and the size of the internal pore is determined by the determined crystal structure.

In the beta zeolite containing copper according to the present exemplary embodiment, the copper may be included in the beta zeolite in the form of copper ions (cations) and a copper oxide (nanoparticles).

Specifically, in the beta zeolite, a central atom, such as Si or Al, forms a tetrahedral structure with an oxygen atom.

On the other hand, since Si is 4+, the charge balance is implemented even when Si bonds with 4 oxygens, whereas, since Al is 3+, when Si bonds with 4 oxygens, the charge balance is not implemented.

Therefore, one oxygen atom attached to Al pulls a cation from the outside of the beta zeolite structure to balance the charge, and in this case, copper ions existing in the form of Cu⁺ or Cu²⁺ (Cu²⁺ is substituted in the form of a bridge at two cation sites) are bound to the inside of the beta zeolite. In addition, the copper oxide may be provided outside the beta zeolite in the form of nanoparticles. The copper oxide may be provided in the form of nanoparticles having an average diameter of 10 nm or less.

In the beta zeolite containing copper of the present invention, the ratio of copper ions and copper oxide together with the Si/Al ratio related to the crystal structure of the zeolite may affect each other in adsorbing the hydrocarbon.

The Si/Al ratio of the beta zeolite may control the size and shape of pores resulting from the crystal structure of the beta zeolite, and at the same time, may control the ratio of copper ions and copper oxide contained in the beta zeolite. The copper ion is included in the crystal structure of the beta zeolite to affect the pore size of the beta zeolite, thereby adsorbing hydrocarbon having a small molecular size. In addition, the copper oxide may eliminate the hydrocarbon by oxidizing the hydrocarbon.

The hydrocarbon adsorbent according to the exemplary embodiment may improve adsorption of hydrocarbon by controlling the crystal structure of the beta zeolite by the Si/Al ratio, and improve the adsorption of the hydrocarbon of a small molecular size by controlling the ratio of copper ions and copper oxide by adjusting the Si/Al ratio and the content of Cu to oxidize and eliminate the hydrocarbon by the copper oxide.

The beta zeolite containing copper according to the present exemplary embodiment may have a crystal structure in which a 20 value in an X-ray diffraction (XRD) pattern has a peak in the range of 5° to 10°, and a Full Width at Half Maximum (FWHM) existing in the range of the 20 value of 5° to 10° is 1.2 to 1.5. Specifically, in the beta zeolite containing copper, the 20 value in the X-ray diffraction (XRD) pattern may be approximately 7° to 8°, more specifically 7.7°.

As described above, the crystal structure of the beta zeolite containing copper may be changed by including copper, and in each of the beta zeolite containing copper and the beta zeolite containing no copper (beta zeolite having the same ratio of Si/Al before including copper), the 20 value has the peak in the range of 5° to 10° in the X-ray diffraction (XRD) pattern, and in the FWHM existing in the range of the 20 value of 5° to 10°, a ratio (FWHM_bare/FWHM_Cu) of the FWHM (FWHM_bare) of the beta zeolite containing no copper to the FWHM (FWHM_Cu) of the beta zeolite containing copper may be less than 1.

The amount of adsorbed propene of the beta zeolite containing copper according to the present exemplary embodiment may be 0.03 mmol/g or greater.

According to another aspect of the present invention, the present invention may include a hydrocarbon eliminating method using the beta zeolite containing copper described above.

The hydrocarbon eliminating method may include: trapping hydrocarbons by using beta zeolite containing copper at a temperature lower than 150° C.; desorbing the trapped hydrocarbon at a temperature of 150° C. or greater; and oxidizing the desorbed hydrocarbon.

A Si/Al molar ratio of the beta zeolite may be 12.5 to 150 and a content of the copper may be 1 wt % to 10 wt % based on the total weight of the beta zeolite.

The copper may include copper ions or copper oxide.

The copper oxide is provided in the form of particles of 10 nm or less on the surface of the beta zeolite, the copper ions trap hydrocarbons at a temperature lower than 150° C., and oxidize the hydrocarbons in the oxidation operation, and the oxidation operation may be performed at a temperature of 150° C. or higher.

Specifically, each of the copper ion (cation) and copper oxide (existing in the form of particles having a size of 10 nm or less on the surface of the beta zeolite) may adsorb and eliminate hydrocarbons.

The copper ion may adsorb hydrocarbon, such as propene, that is difficult to be trapped by the structure (pore) of the beta zeolite because its size is too small.

In this case, since the propene has polarity, the cation may be fixed by electrostatic attraction with the copper ions.

On the other hand, relatively large hydrocarbon, such as toluene, is adsorbed by the crystal structure of the beta zeolite, and some of the hydrocarbons may be adsorbed by the copper ions.

The adsorption of the hydrocarbon by the copper ion may be mainly performed at a low temperature lower than 150° C., and in the region where the temperature rises to 150° C. or higher, hydrocarbons may be eliminated by a method of oxidizing the hydrocarbon by the copper oxide.

Hereinafter, a hydrocarbon adsorbent according to an exemplary embodiment of the present invention will be described through specific examples.

### Example 1 Cu/ZSM5 Zeolite Synthesis

Cu was impregnated into H⁺-form ZSM-5 particles by using a wet impregnation method. Specifically, copper nitrate trihydrate (Cu(NO₃)₂·3H₂O, 98%, Sigma-Aldrich) is dissolved in deionized water to prepare a solution of 0.04 M copper II nitrate (Cu(NO₃)₂). The H⁺-form ZSM-5 particles were added to the copper nitrate solution so that 5 wt % of Cu based on the total weight of the ZSM-5 zeolite was finally impregnated. Then, the mixture was placed in a rotary evaporator, and after eliminating all moisture, the Cu-impregnated ZSM-5 was recovered to be dried at a temperature of 100° C. for about 6 hours or more, and it was calcined at a temperature of 550° C. for 6 hours at a heating rate of 1° C./min under an air flow of 300 mL/min.

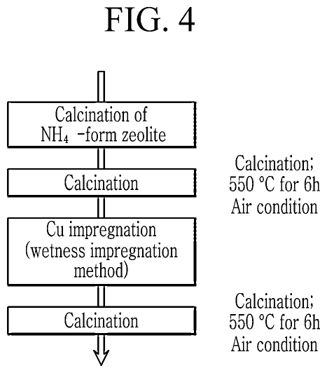

A manufacturing process according to Example 1 is shown in FIG. 4.

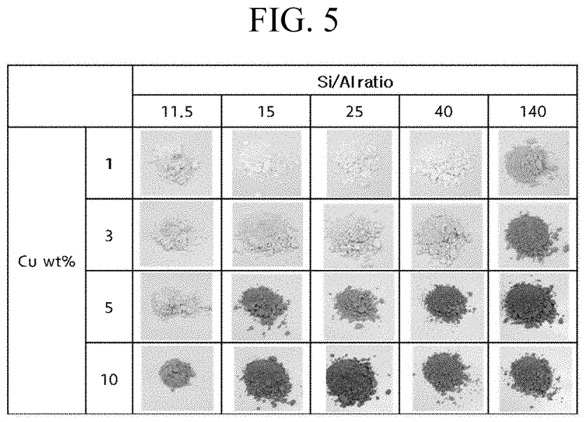

After the content of Cu and the Si/Al molar ratio were differently prepared according to the manufacturing method of Example 1, samples prepared with each content were as shown in FIG. 5.

### Evaluation Example 1: HC Trap Adsorption/Desorption Performance Evaluation Test in Cold-Start Section

After 60 mg of Cu/ZSM-5 zeolite respectively prepared in Example 1 was pre-treated for 30 minutes at a temperature of 600° C. under He flow in a reaction tube, it was adsorbed for 5 minutes at a temperature of 70° C. in C₃H₆, C₇H₈, CO, H₂, O₂, CO₂, H₂O, a carrier Ar/He mixed gas (Lambda 1 condition mixed gas) under C₃H₆, C₇H₈, O₂, carrier gas Ar/He mixed gas flow for 5 minutes, and then the adsorption/desorption performance was evaluated while raising a temperature at a heating rate of 53° C./min.

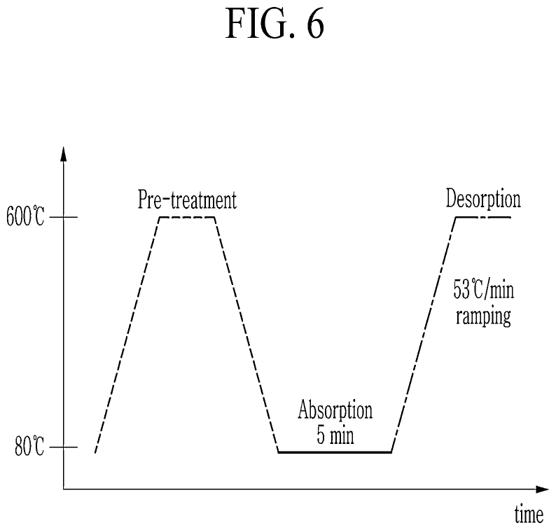

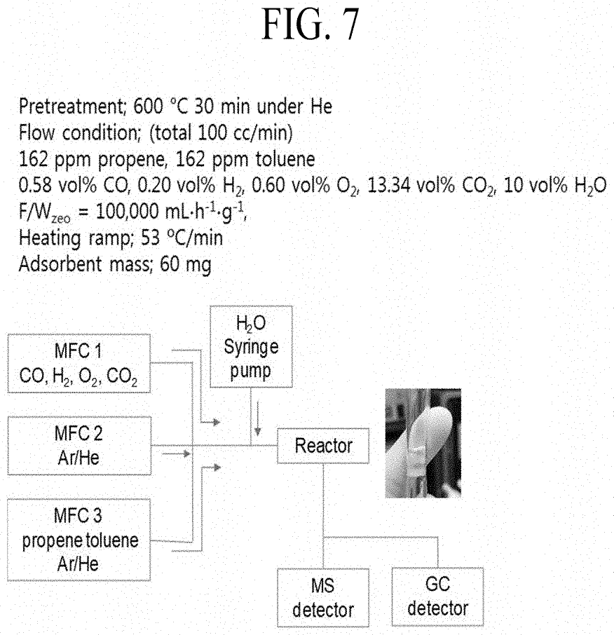

FIG. 6 illustrates process conditions of pre-treatment, adsorption, and desorption. FIG. 7 illustrates process conditions and a reaction flowchart of an adsorption/desorption evaluation test.

### Evaluation Example 2: Adsorption Performance Evaluation According to Carbon Atoms of Hydrocarbon

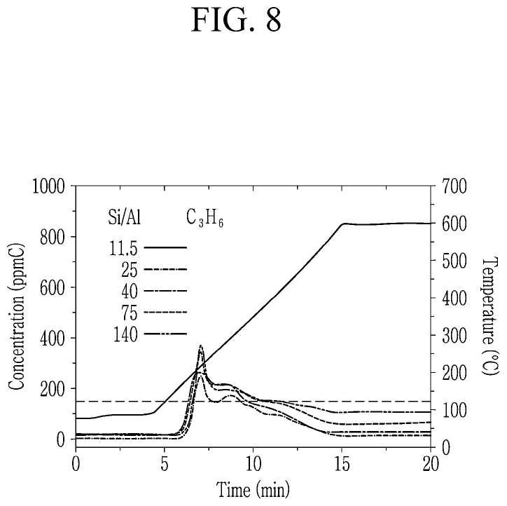

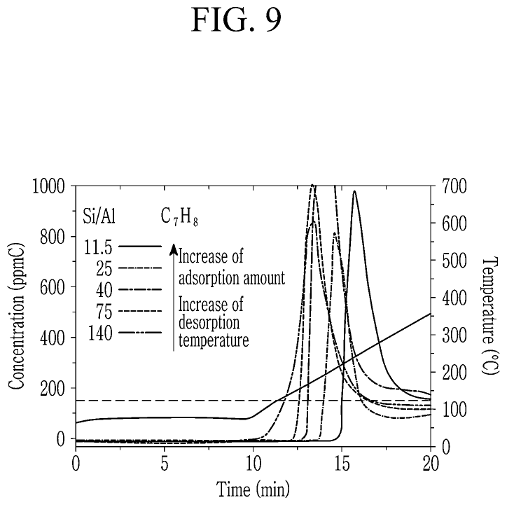

Adsorption performance for C₃H₆ and adsorption performance for C₇H₈ were measured in the same manner as in Evaluation Example 1 for ZSM-5 zeolites having different Si/Al contents shown in FIG. 8 and FIG. 9.

As a result, it was confirmed that the Si/Al ratio of ZSM-5 affects the hydrocarbon adsorption performance. Particularly, it was confirmed that an improvement effect was remarkable in hydrocarbon (C₇H₈) having large carbon atoms. According to the results of Evaluation Example 2, the smaller the Si/Al ratio, the better the hydrocarbon adsorption amount and the high temperature adsorption performance, which is determined to be due to an increase in the Brønsted acid site.

### Evaluation Example 3: Adsorption and Purification Performance Evaluation of HC Trap According to Supported Cu

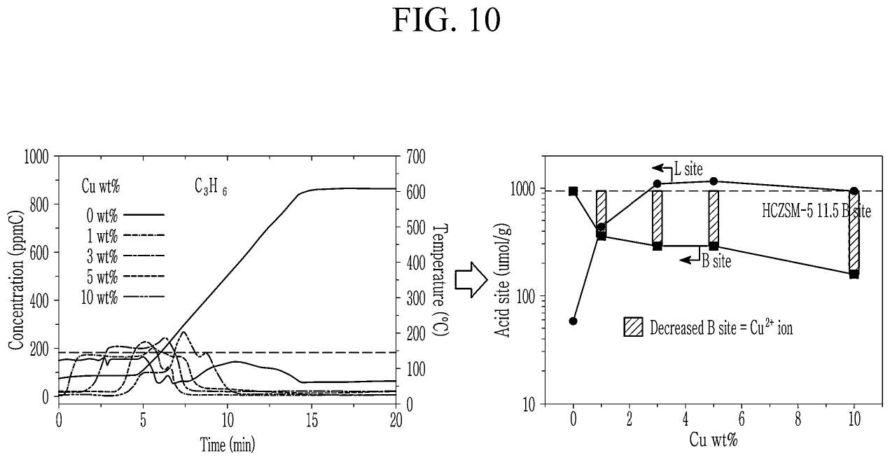

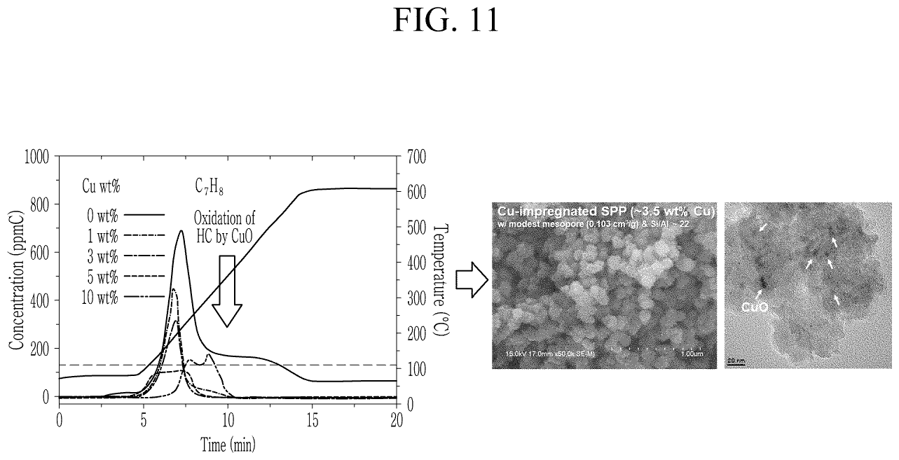

Adsorption performance for C₃H₆ and adsorption performance for C₇H₈ were measured in the same manner as in Evaluation Example 1 for ZSM-5 zeolites supporting Cu of different contents shown in FIG. 10 and FIG. 11.

As a result, it was confirmed that in the hydrocarbon adsorption performance of ZSM-5 supporting Cu, the larger the Cu supporting content, the higher the high temperature adsorption performance and the adsorption amount of C₃H₆. This is a result of ion exchange of a portion of the supported Cu, resulting in an increase in the Lewis acid site. In addition, it was confirmed that CuO, which does not participate in the ion exchange and is dispersed on an outer wall of the ZSM-5, contributed to fast hydrocarbon oxidation reaction during hydrocarbon desorption.

### Evaluation Example 4: Adsorption and Purification Performance of HC Trap According to Supported Cu and Si/Al Molar Ratio

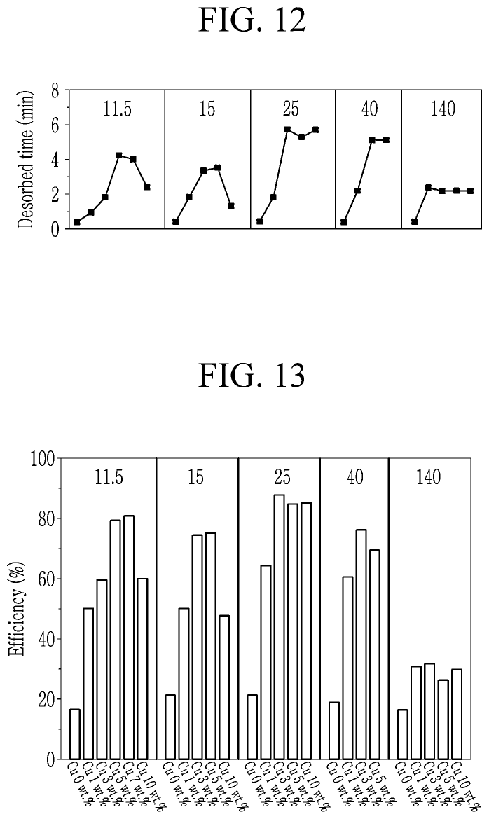

Adsorption and purification performance of each sample prepared in Example 1 and shown in FIG. 4 were measured and shown in FIG. 12 and FIG. 13.

As a result, it was confirmed that the hydrocarbon adsorption and purification performance was significantly improved by the Si/Al molar ratio and supported Cu.

It was confirmed that a preferred Si/Al molar ratio for obtaining efficiency of 50% or greater was 11.5 to 40, and a preferred Si/Al molar ratio for obtaining efficiency of 80% or greater was 11.5 to 25.

In the present experiment, the efficiency means an amount (%) of hydrocarbon that was not discharged compared to an amount of hydrocarbon provided up to a temperature of 300° C.

The amount of hydrocarbon was calculated as a value when converted to CH₄. (For example, calculated as C₃H₆→3CH₄, C₇H₈→7CH₄)

For example, when an amount of hydrocarbon provided is 100, efficiency is 90% in a case in which an amount of hydrocarbon discharged is 10.

In addition, it was confirmed that a preferred copper content for obtaining efficiency of 50% or greater was 1 wt % to 10 wt % based on the total weight of the ZSM-5 zeolite, and a preferred copper content for obtaining efficiency of 80% or greater was 1 wt % to 3 wt % based on the total weight of the ZSM-5 zeolite.

More specifically, when the Si/Al molar ratio was 11.5 to 40 and the copper content was 3 wt % to 10 wt % based on the total weight of the ZSM-5 zeolite, the hydrocarbon adsorbent suppressed the hydrocarbon emission by 55% or greater. In addition, when the Si/Al molar ratio was 25 to 40 and the copper content was 5 wt % to 10 wt % based on the total weight of the ZSM-5 zeolite, the hydrocarbon adsorbent suppressed the hydrocarbon emission by 60% or greater.

Similarly, when the Si/Al molar ratio was 15 to 25 and the copper content was 3 wt % to 5 wt %, the hydrocarbon adsorbent suppressed the hydrocarbon emission by 70% or greater.

### Evaluation Example 5: Comparison with Cu/Beta Zeolite

Although Evaluation Example 5 is similar to Evaluation Example 4, beta zeolite was used instead of ZSM-5 as the zeolite, the Si/Al molar ratio was varied from 12.5 to 150, and the same experiment as in Evaluation Example 4 was performed while changing the Cu content from 1 wt % to 10 wt % based on the total weight of the ZSM-5 zeolite.

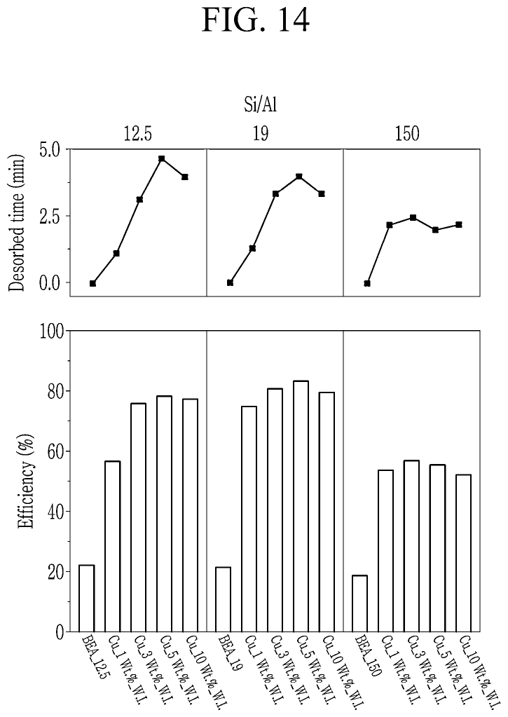

The results are shown in FIG. 14.

As a result, when the Si/Al molar ratio was 12.5 to 19 and the copper content was 1 wt % to 10 wt %, it was confirmed that remarkable efficiency was obtained.

### Example 2 Cu/Beta Zeolite Synthesis

NH⁴⁺-form BEA zeolites with Si/Al of 12.5, 19, 30, 65, and 150 were calcined at 550° C. for 12 h at a ramp rate of 1° C.·min⁻¹ under an air flow of 300 mL·min⁻¹, yielding H⁺-form BEA zeolite. Subsequently, the H⁺-form BEA zeolite particles were impregnated with copper using the wet impregnation method. Specifically, 0.192, 0.588, 1.001, 1,431, and 2,112 g of copper precursor (copper nitrate trihydrate; Cu(NO₃)₂·3H₂O, 98%, Sigma-Aldrich) were dissolved in 83.4 g of deionized (DI) water, respectively. Then, 5 g of H⁺-form BEA zeolite samples were added to the corresponding copper precursor solution to achieve a copper portion of 1, 3, 5, or 10 wt % in the BEA zeolite-supported form. Each mixture was then placed in a rotary evaporator to remove the DI water. After the removal of the water, the particles were recovered and dried at 100° C. overnight under ambient conditions. Finally, the dried particles were calcined at 550° C. for 6 h at a ramp rate of 1° C.·min⁻¹ under an air flow of 300 mL·min⁻¹ in a box furnace (CRF-M30-UP, Pluskolab).

### Evaluation Example 6: Performance Evaluation of Cu/Beta Zeolite

The characteristics of the beta zeolite containing copper for each Cu content and each Si/Al prepared in Example 2 were confirmed by using TEM and XRD, and CST and adsorbed propene were evaluated.

1. Cold-Start Test (CST) Evaluation

For the hydrocarbon adsorbent, which is the beta zeolite containing copper according to the present exemplary embodiment, the CST performance was confirmed to confirm the hydrocarbon adsorption performance at low temperatures.

A certain amount of a sieved Cu-impregnated BEA sample (ca. 0.06 g of 150-250 μm sized pellets) was placed on quartz wool in a quartz tube reactor (inner diameter of ca. 6.9 mm). The samples were activated at 600° C. for 30 min at a ramp rate of ca. 50° C.·min⁻¹ under a He flow of 50 mL·min⁻¹. The temperature and flow rate were controlled using a temperature controller (UP35A, Yokogawa) and a mass flow controller (MFC, High Tech, Bronkhorst), respectively. A thermocouple underneath the quartz wool was used to record the temperature. After completing the activation process, ca. 100 mL·min⁻¹ of simulated exhaust gas was fed to the reactor continuously. The temperature was first maintained at 70° C. for 5 min, further heated to 600° C. at a ramp rate of 53° C.·min⁻¹, and, finally, held at 600° C. for 5 min. In particular, the simulated CST feed was designed to achieve a lambda value of 1. Specifically, the simulated gas stream comprised approximately 162 ppm toluene, 162 ppm propene, 0.6 mol % 02, 0.58% CO, 0.19% H₂, 13.36% CO₂, and 500 ppm Ar balanced with He. Along with this dry feed, 10 mol % water vapor was co-fed to the reactor by injecting water through a syringe pump and evaporating it in heated tubes. The ratio of the total feed flow rate to the used sample weight (on the dry basis) was equal to 100 000 mL·g⁻¹·h⁻¹. The concentration of the outlet stream was analyzed by a mass spectrometer (MS, Lab Questor-RGA, Bongil) and a gas chromatograph equipped with a flame-ionized detector (GC, YL6500, YL Instrument) positioned in series. The MS signals were monitored on-line to track the concentrations of the feed components; specifically, m/z=91 for toluene and 42 for propene. For reliable MS measurements, Ar was used as an internal standard. In parallel, GC was used to monitor the concentration of total HCs in terms of the CH₄ reference.

In the CST graph, the temperature means that the temperature of the hydrocarbon adsorbent is raised over time from 70° C. to 600° C., and total HCs is the hydrocarbon contained in the injected hydrocarbon gas converted to CH₄.

In addition, toluene is adsorbed over time and is not detected in the adsorption graph when the oxidizing performance of the hydrocarbon adsorbent by the copper oxide is sufficient, but toluene is desorbed at 150° C. or higher when the oxidizing performance is insufficient.

Propene is adsorbed in the 70° C. maintaining period, and the adsorption amount gradually decreases with time, so the concentration increases, and at 150° C. or higher, the propene is desorbed and simultaneously oxidized by the copper oxide contained in the hydrocarbon adsorbent, and the concentration decreases again.

2. Amount (Mmol/g) of Adsorbed Propene

For the hydrocarbon adsorbent, which is the beta zeolite containing copper according to the present exemplary embodiment, the performance of adsorbing propene having a small molecular size at low temperature was confirmed.

The amount of adsorbed propene is calculated based on propene molecules that were not detected (assumed to be adsorbed and not detected) in the section maintained at 70° C. for the initial 5 minutes of the CST graph.

In detail, the inlet concentration is a fixed value of 162 ppm, and when adsorption is performed, the profile of the propene graph has a lower concentration value than the inlet concentration. Therefore, the amount of adsorbed propene can be achieved by following equation.

$${\int }_{0 [ min ]}^{5 [ min ]} ( C 3 inlet - C 3 outlet ) [ ppm ] dt \times 100 [ mL / min ] \times \frac{1 [ mol ]}{22.4 [ L ]} \times \frac{1}{0.06 [ g ]} = x [ mmol / g ]$$

In the above equation, the C3 inlet ppm, C3 outlet ppm, 100 mL/min, 1 mol/22.4 L, 0.06 g, and x mmol/g represent the inlet concentration value of the CST gas, the concentration of propene in the CST graph, flow rate of the CST gas, Avogadro's number, weight of HC trap used in CST measurement, and the amount of adsorbed propene, respectively.

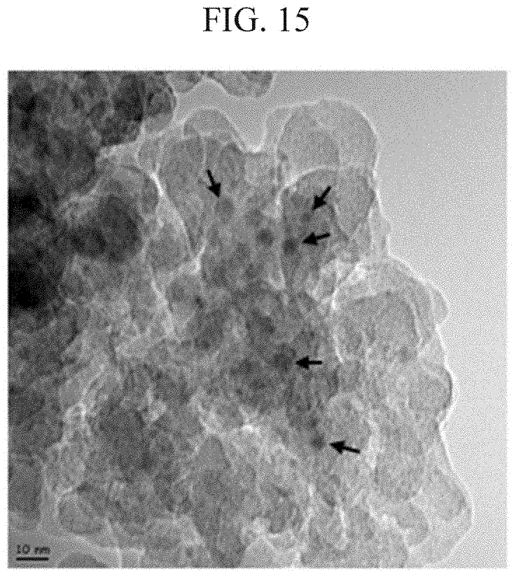

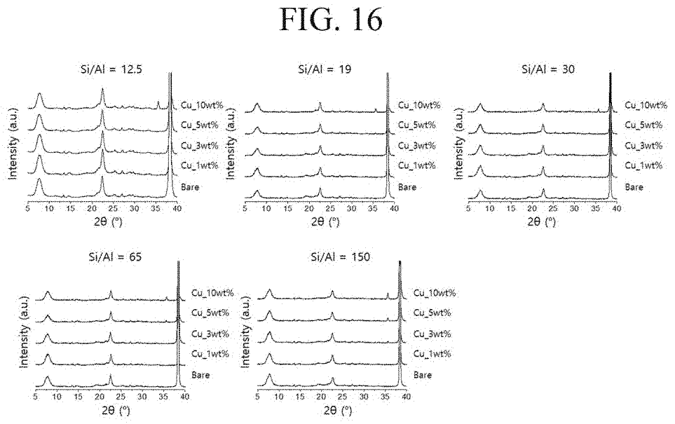

FIG. 15 is a TEM image of BEA Si/Al 12.5 to which 5% of Cu is added, and FIG. 16 is an XRD result of the hydrocarbon adsorbent according to the exemplary embodiment of the present invention.

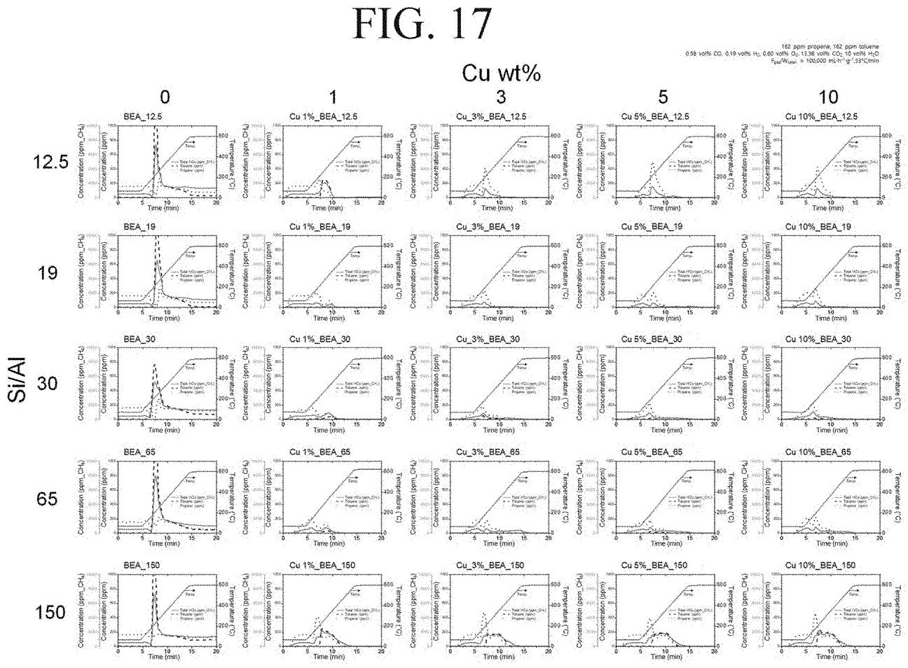

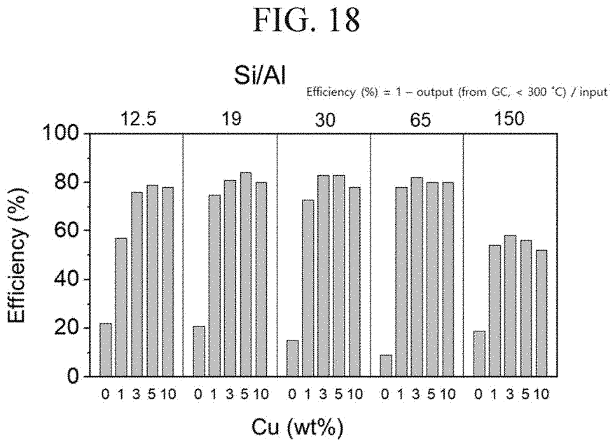

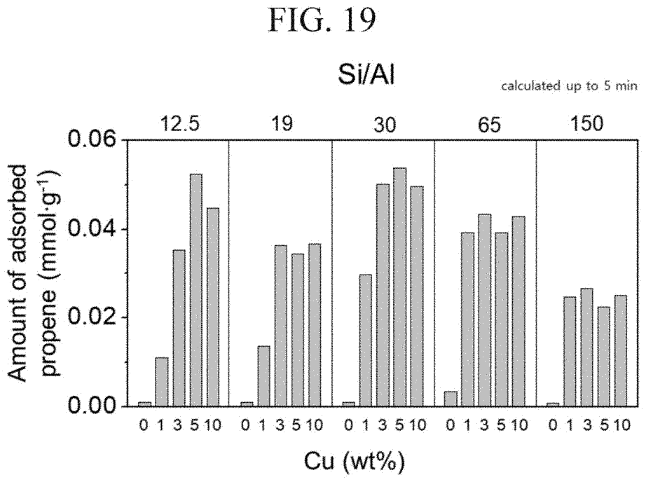

FIG. 17 is a CST graph for the hydrocarbon adsorbent according to the exemplary embodiment of the present invention, FIG. 18 is a result of evaluating the performance of the hydrocarbon adsorbent according to the exemplary embodiment of the present invention, and FIG. 19 is a result of confirming the propene adsorption performance of the hydrocarbon adsorbent of the present invention.

Referring to FIG. 15, the black parts indicated by arrows were nanoparticles of the copper oxide, and it was confirmed that the nanoparticles of the copper oxide appeared on the surface of the beta zeolite. The size of the copper oxide was approximately 10 nm or less.

It can be confirmed that the active site formed in Al of the beta zeolite is substituted with Cu ion, so that Cu exists in a cation state, whereby the beta zeolite has partial polarity.

Therefore, the beta zeolite containing copper may adsorb hydrocarbons by the structural characteristics and at the same time adsorb hydrocarbons having polarity by electrostatic attraction.

In addition, the beta zeolite containing copper may include nanoparticles of the copper oxide on the surface, and the copper oxide may oxidize the hydrocarbon to remove the hydrocarbon.

Table 1 below shows the result that in the X-ray diffraction (XRD) patterns of the beta zeolite containing copper for each Cu content and each Si/Al according to the exemplary embodiment of the present invention, a 20 value has a peak in the range of 5° to 10° (a center value is approximately 7.7°), and the result of the FWHM existing in the range of the 20 value of 5° to 10°.

Table 2 is the result of the ratio of the FWHM (FWHM_bare) of the beta zeolite containing no copper to the FWHM (FWHM_Cu) of the beta zeolite containing copper existing in the range of the 20 value of 5° to 10°.

Referring to FIG. 16 and Tables 1 and 2, the FWHM of the beta zeolite containing copper according to the present exemplary embodiment were min 1.256064 and max 1.418419, and FWHM_bare/FWHM_Cu that is the ratio of the FWHM (FWHM_bare) of the beta zeolite containing no copper to the FWHM (FWHM_Cu) of the beta zeolite containing copper was 1 or less.

Specifically, based on the beta zeolite with Si/Al of 19 to 65, the ratio of the FWHM (FWHM_bare) of the beta zeolite containing no copper to the FWHM (FWHM_Cu) of the beta zeolite containing 3 wt % to 10 wt % of copper was less than 1.

The XRD results are for beta zeolite crystals, and in the beta zeolite containing copper, copper exists as copper ions or copper oxide.

In this case, when the content of copper is low, most of the copper exists inside the beta zeolite in the form of copper ions, but when the content of copper increases, some of the copper is coated on the outside of the beta zeolite in the form of copper oxide, and thus the XRD value changes.

It was confirmed that the copper ion content and the copper oxide content were changed depending on the amount of copper added and the value of Si/Al.

TABLE 1

| | FWHM_Cu | | | | |
|---|---|---|---|---|---|
| | Si/Al = | Si/Al = | Si/Al = | Si/Al = | Si/Al = |
| | 12.5 | 19 | 30 | 65 | 150 |
| Cu (wt %)_0 | 1.418419 | 1.387321 | 1.414496 | 1.388019 | 1.375895 |
| Cu (wt %)_1 | 1.352858 | 1.319375 | 1.31219 | 1.292938 | 1.285714 |
| Cu (wt %)_3 | 1.314644 | 1.29517 | 1.280295 | 1.283103 | 1.256064 |
| Cu (wt %)_5 | 1.343839 | 1.315509 | 1.300914 | 1.26795 | 1.271534 |
| Cu (wt %)_10 | 1.325823 | 1.308556 | 1.305689 | 1.282054 | 1.257316 |

TABLE 2

| | FWHM_bare/FWHM_Cu | | | | |
|---|---|---|---|---|---|
| | Si/Al = | Si/Al = | Si/Al = | Si/Al = | Si/Al = |
| | 12.5 | 19 | 30 | 65 | 150 |
| Cu (wt %)_0 | 1 | 0.978076 | 0.997234 | 0.978568 | 0.97002 |
| Cu (wt %)_1 | 1 | 0.97525 | 0.969939 | 0.955709 | 0.950368 |
| Cu (wt %)_3 | 1 | 0.985186 | 0.973872 | 0.976007 | 0.95544 |
| Cu (wt %)_5 | 1 | 0.978919 | 0.968059 | 0.943528 | 0.946195 |
| Cu (wt %)_10 | 1 | 0.986976 | 0.984814 | 0.966988 | 0.948328 |

Table 3 is the result showing the efficiency of the hydrocarbon adsorbent of FIG. 18, and Table 4 is the result showing the amount of adsorbed propene in FIG. 19. In Table 3, the efficiency is a value based on the outflow amount to the inflow amount, and was confirmed by GC at a temperature of 300° C. or lower. FIG. 18 and Table 3 are values obtained by using the CST results of FIG. 17.

Table 3 and FIG. 18 relate to the hydrocarbon adsorption efficiency of the hydrocarbon adsorbent, since the temperature at which the three-way catalyst is activated is approximately 300° C., the efficiency in the entire temperature range for the CST results of FIG. 17 was not calculated, but the efficiency was calculated when the temperature reaches 300° C. after the temperature was maintained at 70° C. and then raised.

In the CST result graph of FIG. 17, the efficiency was calculated at approximately 9 to 10 minutes in terms of time, and the calculation formula is as follows.

$$Efficiency ( \% ) = ( 1 - \frac{\int {C}_{HC . outlet}}{\int {C}_{HC , inlet}} ) \times 100.$$

Referring to Table 3 and FIG. 18, it was confirmed that the efficiency was 70% or more when Si/Al was 19 to 65 and the content of copper was 3 wt % to 10 wt %.

Referring to Table 4 and FIG. 19, it was confirmed that the efficiency of adsorbing propene having small molecular weight was excellent when Si/Al was 12.5 to 65 and the content of copper was 3 wt % to 10 wt %.

TABLE 3

| | Efficiency of hydrocarbon adsorbent | | | | |
|---|---|---|---|---|---|
| | Si/Al = | Si/Al = | Si/Al = | Si/Al = | Si/Al = |
| | 12.5 | 19 | 30 | 65 | 150 |
| Cu (wt %)_0 | 22 | 21 | 15 | 9 | 19 |
| Cu (wt %)_1 | 57 | 75 | 73 | 78 | 54 |
| Cu (wt %)_3 | 76 | 81 | 83 | 82 | 58 |
| Cu (wt %)_5 | 79 | 84 | 83 | 80 | 56 |
| Cu (wt %)_10 | 78 | 80 | 78 | 80 | 52 |

TABLE 4

| | Amount (mmol/g) of adsorbed propene | | | | |
|---|---|---|---|---|---|
| | Si/Al = | Si/Al = | Si/Al = | Si/Al = | Si/Al = |
| | 12.5 | 19 | 30 | 65 | 150 |
| Cu (wt %)_0 | 0.001103 | 0.001032 | 0.000992 | 0.003506 | 0.000814 |
| Cu (wt %)_1 | 0.011135 | 0.013552 | 0.029782 | 0.039255 | 0.024681 |
| Cu (wt %)_3 | 0.035286 | 0.03626 | 0.050156 | 0.043445 | 0.02664 |
| Cu (wt %)_5 | 0.052461 | 0.034377 | 0.053882 | 0.039181 | 0.022503 |
| Cu (wt %)_10 | 0.044739 | 0.036604 | 0.049596 | 0.042864 | 0.025133 |

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed:

1. A hydrocarbon adsorbent, comprising:
a beta (BEA) zeolite containing copper,
wherein a Si/Al molar ratio of the beta zeolite is 12.5 to 150,
a content of the copper is 1 wt % to 10 wt % based on the total weight of the beta zeolite, and
efficiency of the hydrocarbon adsorbent is 50% or greater.

2. The hydrocarbon adsorbent of claim 1, wherein the Si/Al molar ratio of the beta zeolite is 19 to 65,
the content of the copper is 3 wt % to 10 wt % based on the total weight of the beta zeolite, and
efficiency of the hydrocarbon adsorbent is 70% or greater.

3. The hydrocarbon adsorbent of claim 1, wherein the hydrocarbon includes a hydrocarbon having 3 to 15 carbon atoms.

4. The hydrocarbon adsorbent of claim 1, wherein the beta zeolite containing copper has a peak in the range of 20 value of 5° to 10° in an X-ray diffraction (XRD) pattern, and a Full Width at Half Maximum (FWHM) existing in the range of the 20 value of 5° to 10° is 1.2 to 1.5.

5. The hydrocarbon adsorbent of claim 4, wherein each of the beta zeolite containing copper and the beta zeolite containing no copper has a peak in the range of 20 value of 5° to 10° in the XRD pattern, and
in the FWHM existing in the range of the 20 value of 5° to 10°, a ratio of an FWHM (FWHM_bare) of the beta zeolite containing no copper to an FWHM (FWHM_Cu) of the beta zeolite containing copper is less than 1.

6. The hydrocarbon adsorbent of claim 1, wherein the amount of adsorbed propene of the hydrocarbon adsorbent is 0.03 mmol/g or greater.

7. A hydrocarbon eliminating method, comprising:
trapping hydrocarbons by using beta zeolite containing copper at a temperature lower than 150° C.;
desorbing the trapped hydrocarbon at a temperature of 150° C. or greater; and
oxidizing the desorbed hydrocarbon,
wherein a Si/Al molar ratio of the beta zeolite is 12.5-150 and a content of the copper is 1 wt % to 10 wt % based on the total weight of the beta zeolite.

8. The hydrocarbon eliminating method of claim 7, wherein the copper includes copper ions or copper oxide,
the copper oxide is provided in the form of particles of 10 nm or less on a surface of the beta zeolite,
the copper ion traps a hydrocarbon at temperatures of 150° C. or lower,
in the oxidizing operation, the hydrocarbon is oxidized, and
the oxidizing operation is performed at 150° C. or higher.
